(19) United States
(12) Patent Application Publication
(10) Pub. No.: US 2025/0121253 A1
(43) Pub. Date: Apr. 17, 2025

(54) CAMMING CLAMPING DEVICE AND METHOD FOR MANUFACTURING A CAMMING CLAMPING DEVICE

(71) Applicant: ZEDEL, Crolles (FR)

(72) Inventors: Pierre PLAZE, Chignin (FR); Aurélie Bergez, Gières (FR); Alain Maurice, Le Plateau des Petites Roches (FR)

(73) Assignee: ZEDEL, Crolles (FR)

(21) Appl. No.: 18/916,150

(22) Filed: Oct. 15, 2024

(30) Foreign Application Priority Data
Oct. 13, 2023 (FR) 2311066

(51) Int. Cl. A63B 29/02; F16B 2/18

(52) U.S. Cl. CPC A63B 29/024; F16B 2/18

(57) ABSTRACT

A camming clamping device includes a head, a cam and a spring biasing the cam to an extended position. A textile wire element connects the cam to a trigger fitted movable between first and second positions. The cam defines a first hole and a second hole. The textile wire element passes through the first hole and second hole to introduce friction between the textile wire element and the cam. A terminal portion of the textile wire element passes through a third hole connecting the sides of the cam and/or is wedged in a groove arranged in one of the sides. The terminal portion of the textile wire element is arranged posteriorly to the second hole in a longitudinal direction of the textile wire element away from the trigger.

### BACKGROUND OF THE INVENTION

The invention relates to a camming clamping device and to a method for manufacturing a camming clamping device.

### PRIOR ART

During climbing phases, a climber is required to place protection points in a rockface. The climber successively installs several protection points that are designed to support him in case of a fall. Some rockfaces are equipped with pre-installed protection points, for example in the form of spits that are sealed in the rock. Other rockfaces are not equipped with such points which means that the climber has to find the crevice that is most suitable for installing his protection point.

When the climber has to place his protection points, it is conventional to install passive chocks and active chocks. The chocks are designed to be inserted in crevices that are generally holes, cracks, channels or any other recess that is deep enough for a chock to be inserted. Each particular shape of crevice is suitable for a particular chock configuration. Passive chocks are often formed by metal parts having a specific shape. In a first spatial position, the chock can be inserted in a fault of a rockface and, in a second spatial position, the chock is wedged between two opposite faces. It is then possible to install and remove the chock easily or to wedge the chock provided that the latter is placed in the right spatial configuration inside the hole.

In addition to passive chocks, active chocks are known also called camming chocks or camming clamping devices. The camming chock is provided with a head having a plurality of cams. The cams are fitted in movable manner around one or more rotation shafts.

The cams move between a retracted position and an extended position. In the retracted position, the size of the head is smaller than in the extended position. The chock head is inserted in a crack in its retracted position and the cams then seek to move to the extended position pressing the cams against the two opposite faces of a crack. The shape of the cams has the effect of increasing the force applied on the faces of the crack when a pull is exerted on the chock.

In conventional manner, a camming chock has a head provided with several rotary cams at a first end. The second end of the camming chock is an annular end that is configured to receive a carabiner and to act as anchor point for the climber.

Actuation of the cams is achieved by means of a trigger that is fitted movable sliding along a rod. When the user pulls on the trigger in the direction of the annular end, the cams move to the retracted position. When the user stops pulling, a spring returns the cams to the extended position.

The movable cam or cams are mounted pivoting and are connected to the trigger by one or more wire elements that are generally steel cables of piano wire type. In conventional manner, each of the ends of the steel cable is fixed to a movable cam and the steel cable passes through the trigger to form the mechanical connection between the cams and the trigger. Securing can be performed by crimping or heading. As the cross-section of the steel cable is small, the cable deteriorates quickly and it is common for it to break requiring a repair operation in an approved centre. Furthermore, securing the cable with the rotary cam is all the more difficult the more the cross-section of the cable decreases and the smaller the cross-section of the rotary cam.

In an alternative embodiment, the steel cable is replaced by a textile cable. Each end of the cable is fixed to a cam. Each cam is provided with a hole for the textile cable to be able to pass through the cam. The end of the textile cable is fixed to the cam by adhesion and/or by means of a knot having a cross-section that is larger than the cross-section of the hole. Securing by adhesion or by means of a knot becomes increasingly complicated as the size of the chock decreases due to the fact that the thickness of the knot results in the textile cable extending beyond the cam and/or the length of cable becoming difficult to master.

When manufacturing of the camming clamping device is performed, an uncertainty exists as to the length of the wire element before the latter is fixed to the trigger and to the cams and an uncertainty exists as to the effective length of the wire element after the attachment step to the cams. These different variations mean that the behaviours of the camming clamping devices may vary or have to be compensated by springs serving the purpose of separating the trigger and cams to stretch the wire element.

### OBJECT OF THE INVENTION

One object of the invention consists in providing a camming clamping device the mechanical connection whereof between the trigger and the movable cam is better mastered and is preferentially easier to replace.

According to one feature of the invention, the camming clamping device comprises:
a head;
at least one cam installed in movable manner pivoting around at least one pivot shaft, the at least one cam being movable between a retracted position and an extended position, the at least one pivot shaft being fixed to the head, the at least one cam defining at least a first hole and a second hole that are pass-through between a first side and a second side of the at least one cam;
a spring functionally coupled to the at least one cam to bias the at least one cam to the extended position;
an annular end mechanically coupled to the head;
a rod extending from the head to the annular end;
a trigger mounted movable between a first trigger position and a second trigger position,
a textile wire element having a first end installed fixedly with the at least one cam, the textile wire element connecting the trigger mechanically to the at least one cam, the textile wire element coupling the trigger functionally with the at least one cam, when the trigger is in the second trigger position the at least one cam is in the retracted position.

The camming clamping device is remarkable in that the textile wire element passes through the first hole and the second hole to introduce friction between the textile wire element and the at least one cam, and in that a terminal portion of the textile wire element passes through a third hole connecting the first side and the second side and/or is wedged in a groove arranged in the first side or the second side, the terminal portion of the textile wire element being arranged posteriorly to the second hole in a longitudinal direction of the textile wire element heading away from the trigger.

The cam preferably defines the third hole. A downline strand of the textile wire element is wedged against a face of the at least one cam by an upline strand of the textile wire element, the downline strand being located farther from the trigger than the upline strand in the longitudinal direction of the textile wire element.

In advantageous manner, the at least one cam defines the at least one groove. A terminal end of the textile wire element is embedded in the at least one groove.

In a particular configuration, the groove connects the first hole and the third hole.

In an advantageous development, the downline strand is wedged in the groove.

Preferentially, the textile wire element passes successively via the first hole and the second hole in the longitudinal direction of the textile wire element heading away from the trigger. The first hole defines a first end with the first side and a second end with the second side. The textile wire element enters the first hole via the second side, the second end forming a second pressing area of the textile wire element. The second pressing area has an edge that is less sharp than the first end of the first hole and/or than an edge of one end of the second hole with one and/or the other of the first side and the second side.

According to one embodiment, a side wall of the first hole connects a face of the at least one cam forming the second side. The pressing area of the second end is an arc of a circle having a radius of curvature at least equal to half the thickness of the textile wire element.

In an advantageous development, the side wall of the first hole defines a sharp edge with the second face of the at least one cam and/or a side wall of the second hole defines a sharp edge with the first face or the second face of the at least one cam.

Preferentially, the first hole and second hole open into a thinned area of the at least one cam, the thinned area representing a thinning at least equal to a thickness of a strand of the textile wire element.

In another advantageous development, the cross-section of the textile wire element is smaller than the cross-section of the first hole and of the second hole from one end of the textile wire element to the other in the longitudinal direction of the textile wire element.

Preferentially, the textile wire element is only fixed to the at least one cam by wedging in the groove and/or by friction at the ends of the first hole, the second hole and the third hole.

In an advantageous configuration, the at least one cam has a first cam and a second cam. The textile wire element has a first end fixed to a first cam and an opposite second end fixed to the second cam.

It is a further object of the invention to provide a method for manufacturing a camming clamping device with a support wire element that is easy to implement and in particular that enables a textile wire element to be easily secured with a cam while achieving an efficient mechanical attachment.

This result tends to be achieved by means of a manufacturing method comprising the following steps:
providing a textile wire element and a camming clamping device provided with:
a head;
at least one cam mounted movable pivoting around at least one pivot shaft, the at least one cam being movable between a retracted position and an extended position, the at least one pivot shaft being fixed to the head, the at least one cam defining at least a first hole and a second hole;
a spring functionally coupled to the at least one cam to bias the at least one cam to the extended position;
an annular end mechanically coupled to the head;
a rod extending from the head to the annular end;
a trigger functionally connected to the at least one cam, the trigger being mounted movable between a first trigger position and a second trigger position, and in the second trigger position the at least one cam is in the retracted position.

The manufacturing method is remarkable in that the at least one cam comprises at least a third hole and/or at least one groove;
wherein the wire element passes through the first hole, the second hole and the at least a third hole to form consecutive friction areas between the textile wire element and the at least one cam along a longitudinal direction of the textile wire element; and/or
wherein the at least one groove has a width smaller than or equal to a width of the textile wire element, the textile wire element being embedded by deformation in the at least one groove.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a perspective view of a camming clamping device;

FIG. 2 schematically illustrates a side view of a camming clamping device;

FIG. 3 schematically illustrates a front view of a camming clamping device;

FIG. 4 schematically illustrates a perspective view of a movable cam and of a textile wire element;

FIG. 5a schematically illustrates a view of the first side of a movable cam with a textile wire element strand;

FIG. 5b schematically illustrates a sectional view along AA of the movable cam;

FIG. 5c schematically illustrates a view of the second side of a movable cam;

FIG. 6a schematically illustrates a view of the first side of a movable cam with a textile wire element strand;

FIG. 6b schematically illustrates a sectional view along AA of the movable cam with a textile wire element strand that passes through the movable cam several times;

FIG. 6c schematically illustrates a view of the second side of a movable cam with a textile wire element strand;

FIG. 7 schematically illustrates a perspective view of another camming clamping device;

FIG. 8 schematically illustrates a side view of another camming clamping device;

FIG. 9 schematically illustrates a front view of another camming clamping device;

FIG. 10 schematically illustrates a perspective view of a movable cam and of a textile wire element of another camming clamping device;

FIG. 11a schematically illustrates a view of the first side of a movable cam of another camming clamping device;

FIG. 11b schematically illustrates a sectional view along AA of the movable cam of another camming clamping device;

FIG. 11c schematically illustrates a view of the second side of a movable cam of another camming clamping device;

FIG. 12a schematically illustrates a view of the first side of a movable cam with a textile wire element strand of another camming clamping device;

FIG. 12b schematically illustrates a sectional view along AA of the movable cam with a textile wire element strand that passes through the movable cam of another camming clamping device several times;

FIG. 12c schematically illustrates a view of the second side of a movable cam with a textile wire element strand of another camming clamping device.

### DESCRIPTION OF THE EMBODIMENTS

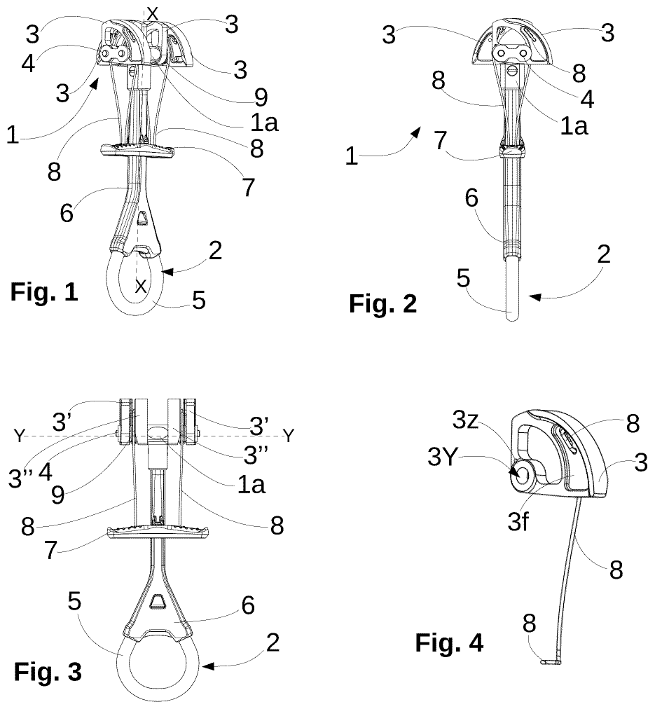

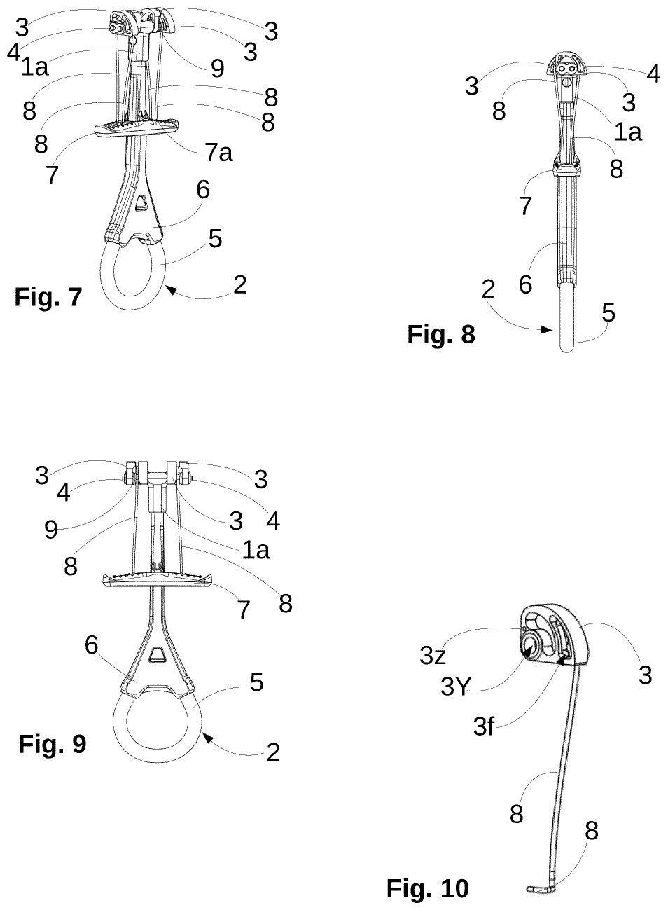

FIGS. 1 to 12c illustrate different embodiments of a camming clamping device also referred to as “camming clamp”. The camming clamping device is preferentially an active clamping device.

The camming clamping device comprises a first end that is provided with a head 1 and an opposite second end that is an annular end 2. The head 1 is coupled to at least one cam 3 and preferably to several cams 3 that are mounted movable pivoting between an extended position and a retracted position. The size in the extended position is larger than the size in the retracted position. The cam or cams 3 are installed movable around at least one pivot shaft 4. The cam or cams 3 are mechanically coupled to the head 1 in order to provide a mechanical continuity between the cams 3 and the annular end 2. The pivot shaft 4 is fixed to the head 1. More precisely, the pivot shaft 4 is fixed to a body 1a of the head 1. The body 1a can be formed by one or more parts. In the embodiment illustrated in FIGS. 1 to 12c, the camming clamping device has two, preferably parallel, pivot shafts 4. In the embodiment illustrated in FIGS. 4, 5a, 5b, 5c, 6a, 6b, 6c, 10, 11a, 11b, 11c, 12a, 12b, 12c, the cam 3 defines an aperture 3Y designed to house the pivot shaft 4 so that cam pivots around the pivot shaft 4.

In conventional manner, the annular end 2 is in the form of a ring that defines a through hole configured to receive a carabiner. The annular end 2 is able to support a user's weight. The ring defines a through hole configured to receive a part of the hand in the actuation phases of cams 3.

The camming clamping device has a wire element 5 that connects the head 1 mechanically to the annular end 2. The wire element 5 couples the cams 3 mechanically to the annular end 2 so that a user attached to the annular end 2 is secured by means of the cams 3 wedged for example in a crack. The wire element 5 is the part that provides the mechanical continuity between the head 1 and the annular end 2. The wire element 5 is fixed to the head 1 so as to mechanically couple the wire element 5 and the head 1. The wire element 5 extends in a first direction XX to provide the mechanical strength in this first direction XX. The pivot shaft 4 extends mainly in a second direction YY that is perpendicular or substantially perpendicular to the first direction XX.

The wire element 5 is fixed to the head 1 and extends continuously from the head 1 until it reaches the annular end 2 to provide the mechanical continuity along the clamping device. The wire element 5 can be in the form of a ring, preferably a ring made from textile material. The wire element 5 can be a strap or a rope. The textile ring can be a ring made from polyethylene of high molar mass, for example made from a material marketed under the tradenames Dyneema or Spectra. A metal wire element, for example a cable, is also able to be used.

In a particular embodiment, the head 1 is provided with an anchorage, preferably an anchorage in the form of a shaft. Preferably, the wire element 5 passes round the anchorage to secure the wire element 5 with the anchorage so as to enable strain take-up with the annular end 2. In other words, the wire element 5 defines at least one loop and the anchorage shaft passes through the loop to perform the strain take-up.

It is advantageous for the ring to be achieved by stitching the two terminations of the wire element 5 onto one another, the wire element 5 being a textile. Stitching is a well-managed technique that makes it possible to easily obtain a ring presenting a mechanical strength that is well mastered. The use of a stitching step enables a ring to be formed that is less expensive and presents a size that is better mastered than its equivalent obtained by splicing. It is advantageous for the ring to be devoid of crimping and splicing.

The clamping device preferentially comprises a rod 6 that extends from the head 1 up to the annular end 2. In preferential manner, the rod 6 is more rigid than the wire element 5 perpendicularly to the first direction XX, which enables the camming clamping device to be held by means of the rod 6 and the clamping device to be placed with greater precision in a crack in comparison with an equivalent device without the rod 6.

The clamping device comprises an actuating system coupled to the at least one cam 3. The actuating system is configured to selectively engage the retracted position of the at least one cam 3. The actuating system has a trigger 7 mounted sliding along a first direction XX connecting the head 1 and the annular end 2. The trigger 7 is mounted sliding along the wire element 5 and along the rod 6 if applicable. The trigger 7 moves with respect to the head 1 and to the annular end 2.

In other words, the trigger 7 is mounted movable with respect to the head 1 and is coupled to the at least one cam 3. The trigger 7 is coupled to the at least one cam 3 so that movement of the trigger 7 away from the head 1 results in movement of the at least one cam 3 to the retracted position. In preferential manner, the trigger 7 is coupled to all the cams 3 so that movement of the trigger 7 away from the head 1 results in movement of cams 3 to their retracted position. The first trigger position is closer to the head 1 than the second trigger position.

The trigger 7 is movable between a first trigger position and a second trigger position. In the first trigger position, the cam or cams 3 can be in the extended position. In the second trigger position, the cam or cams 3 are in the retracted position. Outside the first trigger position, the cam or cams 3 are outside the extended position.

It is advantageous for movement of the trigger 7 in the direction of the head 1 not to impose any movement of the cam 3 and in particular not to result in movement of the cam 3 to the extended position.

In preferential manner, the rod 6 extends continuously from the head 1 up to the annular end 2 so as to provide a good mechanical strength when the clamping device is held by the annular end 2 and the trigger 7. It is advantageous for the trigger 7 to be mounted sliding along the rod 6 and for the rod 6 to separate the wire element 5 and the trigger 7. The rod 6 is preferentially hollow.

In a preferential embodiment, the trigger 7 is mounted sliding along the wire element 5 between the head 1 and the annular end 2. The trigger 7 is coupled to the cam 3 or to each cam 3 by a textile wire element 8. The textile wire element 8 is a textile element, preferably a wire element made from synthetic material, for example from plastic. The textile wire element 8 couples the cam 3 to the trigger 7 and enables a movement of the trigger 7 to be translated to the annular end 2 in a movement of the cam 3 to the retracted position. The textile wire element 8 is illustrated in FIGS. 1, 2, 3, 4, 6a, 6b, 6c, 7, 8, 9, 10, 12a, 12b and 12c.

The textile wire element 8 forms a flexible link between the cam 3 and the trigger 7. The flexible link enables the cam 3 to be biased to the retracted position when the trigger 7 is moved in the direction of the annular end 2. The flexible link does not enable the cam 3 to be biased to the extended position when the trigger 7 is moved in the direction of the head 1.

Advantageously, the trigger 7 presents anchor holes 7a that are designed to enable the textile wire element 8 to pass through the trigger 7. The textile wire element 8 extends from the trigger 7 up to one of the cams 3. Preferentially, the opposite first and second ends of the textile wire element 8 are assembled fixedly to one of cams 3 and the textile wire element 8 is fixed to the trigger 7 so that movement of the trigger 7 towards the annular end 2 makes cams 3 pivot to the retracted position.

The camming clamping device has a spring 9 that is configured to bias the at least one cam 3 to the extended position. The spring 9 can be achieved using any technology, it can be a coil spring working in traction, in compression, in torsion or in flexion. It can also be formed by a blade or a metal strip that is deformed elastically. In the absence of any biasing or obstacle, the spring 9 places the cam or cams 3 in the extended position. The force applied on the trigger 7 to move away from the head 1 corresponds to a force applied on the cam 3 that is opposed to the force applied by the spring 9 to move the cam or cams 3 to the retracted position. In one embodiment, the spring 9 is fixed on the one hand to the cam 3 and on the other hand to the head 1. In another embodiment, the spring 9 is fixed on the one hand to a first cam 3′ and on the other hand to a second cam 3″ that is for example fitted on a pivot shaft 4 other than the first cam 3′. The clamping device can comprise as many springs 9 as cams 3 or as many springs 9 as pairs of cams 3. The springs 9 are illustrated in FIGS. 1 and 3. The FIGS. illustrate attachment holes 3z designed to attach ends of the springs 9.

By biasing the cam or cams 3 to the extended position, the spring 9 biases the trigger 7 to the first trigger position. The spring 9 is configured so that the extended position and the first trigger position are rest positions of the clamping device, i.e. no external load is present.

The camming clamping device comprises at least one rod 6 that extends from the head 1 in the direction of the annular end 2, i.e. in the first direction XX. In the embodiments illustrated in FIGS. 1 to 10, the camming clamping device comprises a single rod 6 that extends longitudinally in the first direction XX against the stop formed by the head 1 and defines the through hole of the annular end 2.

It is particularly advantageous to manufacture the cam or cams 3 from a metallic material, preferentially from an aluminium alloy or a steel.

The use of a textile wire element 8 that performs the mechanical connection between the cam or cams 3 and the trigger 7 is particularly advantageous in comparison with a wire element made from metal. However, it is also important for the clamping device to be able to perform efficient attachment of the textile wire element 8 on the cam 3, i.e. stationary securing of a portion of the textile wire element 8 on a part of the cam 3. The attachment has to resist the forces that exist between the trigger 7 and the cam 3. This precaution enables the movement of the trigger 7 to be translated efficiently to the annular end 2 in the form of pivoting of the cam 3 to the retracted position. It is moreover important for this attachment of the end of the textile wire element 8 not to generate a large volume as this complicates use of the latter for clamping devices of small sizes. Preferentially, the attachment configuration that performs securing between the end of the textile wire element 8 and a cam 3 also performs an adjustment function of the length of the textile wire element 8 to be able to adapt better to the real length of the textile wire element 8 and the separating distance between the rest position of the trigger 7 and the cam 3.

When the latter is formed, the textile wire element 8 is manufactured to present a target length. However, depending on manufacturing uncertainties, the effective length may be slightly longer or shorter than the target length. This has the effect of shifting the position of the trigger 7 with respect to the head 1 and therefore of modifying the operation of the clamping device. If the textile wire element 8 is too short, it is not possible to reach the extended position where the volume of the cam 3 is maximum. If the textile wire element is too long, complete retraction of the cams may not be possible or the excess the textile wire element 8 may interfere with movement of cams 3 or have to be cut off. It is therefore advantageous to provide for the variations of lengths to be able to be compensated when the textile wire element 8 is attached with the cam 3.

The inventors observed that the fact that the textile wire element 8 passes several times through the holes and/or grooves arranged in the cam 3 enables large frictions to be generated between the textile wire element 8 and the cam 3. These frictions enhance the attachment of the textile wire element 8 on the cam 3 and movement of the cam 3 when the trigger 7 is moved towards the annular end 2.

To ensure efficient attachment of one end of the textile wire element 8 with a cam 3, the cam 3 defines at least a first hole 3a and a second hole 3b that are both through holes. These holes connect a first side of the cam 3 with a second side of the cam 3. The first side is opposite the second side in a second direction YY that corresponds to the swivel axis of cam or cams 3. The strand of the textile wire element 8 passes through the first hole 3a and through the second hole 3b. The first hole 3a is distinct from the second hole 3b and the two holes are separated by the strip of material. In other words, the two holes are not contiguous.

To ensure efficient attachment of one end of the textile wire element 8 with a cam 3, the cam 3 defines at least one of a third hole 3c or a groove 3d. The third hole 3c is a through hole that connects the first side and the second side. The third hole 3c can be contiguous to one of the first hole 3a or the second hole 3b or it can be made at a distance from the previous two holes. The groove 3d can be made at the surface of the first side or of the second side. The groove 3d has at least one portion having a width that is greater than or equal to the width of the textile wire element 8. The textile wire element 8 is wedged by embedment in the groove 3d. It is advantageous for the textile wire element 8 to enter the first hole 3a via the second side in the direction of the first side and for the groove 3d to be formed in the first side. The textile wire element 8 enters the first hole 3a via the second side in the direction of the first side on a path following the longitudinal direction of the textile wire element 8 away from the trigger 7.

In other words, a terminal portion of the textile wire element 8 passes through the third hole 3c connecting the first side and the second side and/or is wedged in the groove 3d arranged in the first side or the second side. The terminal portion of the textile wire element 8 is arranged posteriorly to the second hole 3b in a longitudinal direction of the textile wire element 8 away from the trigger 7.

In a particular embodiment illustrated in FIGS. 1 to 12c, the cam 3 defines the first hole 3a, the second hole 3b and the third hole 3c. The textile wire element 8 passes through the first hole 3a, the second hole 3b and the third hole 3c. The textile wire element 8 passes successively through the first hole 3a, the second hole 3b and the third hole 3c in the longitudinal direction of the textile wire element 8 away from the trigger 7. The longitudinal direction is the direction that connects the two opposite ends of the textile wire element 8. For example, the two ends are attached to two different cams 3.

As illustrated in FIGS. 1, 2, 4, 6a, 6b, 6c, 7, 8, 10, 12a, 12b and 12c, the textile wire element 8 runs from the first side to the second side and vice versa passing through the holes. The changes of direction mean that the textile wire element 8 touches the ends of the holes to change direction which induces friction. The multiple frictions help to ensure attachment of the textile wire element 8. Depending on requirements, at least a fourth hole can be envisaged to increase the friction.

The cross-sections of the first hole 3a, the second hole 3b and the third hole 3c can be identical or different. The cross-sections are preferentially slightly larger than or equal to the cross-section of the textile wire element 8 to allow the textile wire element 8 to pass easily when the clamping device is manufactured or when the textile wire element 8 is replaced.

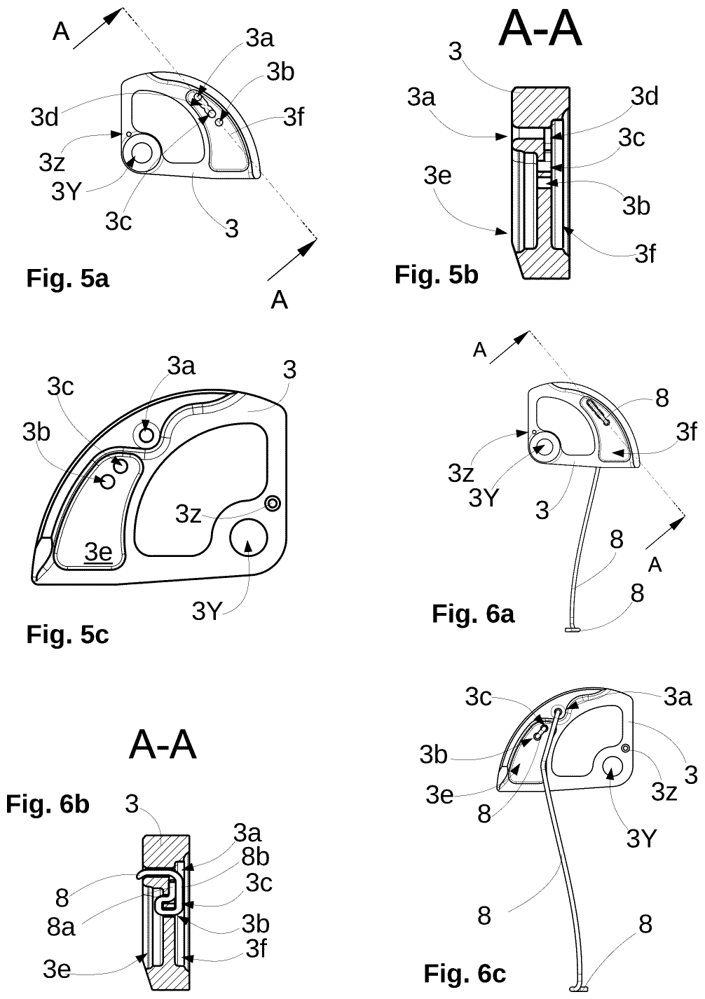

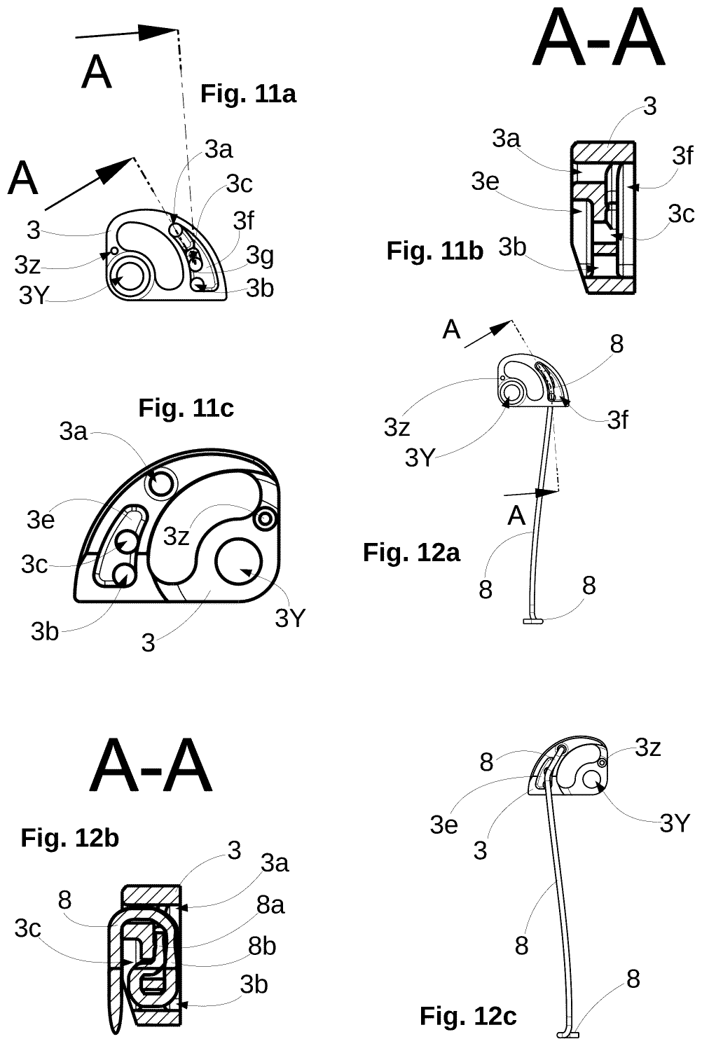

In preferential manner, the third hole 3c is a through hole arranged in the angular sector delineated by the line connecting the swivel axis of the cam 3 and the centre of the first hole 3a and by the line connecting the swivel axis of the cam 3 and the centre of the second hole 3b. Observation is made along the swivel axis of the cam 3 as illustrated in FIGS. 5a, 5c, 11a and 11c. What is meant by centre of the first hole 3a and centre of the second hole 3b is the centre of the circle when the hole is circular or the barycentre of the shape defined by the hole. With such an arrangement, the textile wire element 8 has a portion that is directed in the opposite direction to the direction taken by a previous portion in the longitudinal direction of the textile wire element 8. The direction is observed along the textile wire element 8 from the trigger 7 to the termination of the textile wire element 8.

Advantageously and as illustrated in FIGS. 4, 6a, 6b, 6c, 10, 12a, 12b and 12c, the textile wire element 8 forms a ring surrounding the cam 3. A first strand 8a of the textile wire element 8 is wedged against one face of the cam 3 by a second strand 8b of the textile wire element 8. The first strand 8a of the textile wire element 8 is located farther from the portion connected to the trigger 7 than the second strand 8b in the longitudinal direction of the textile wire element 8. When movement of the trigger 7 takes place towards the annular end 2, the second strand 8b applies a force on the first strand 8a to press the latter against the face of the cam 3. The force applied by the second strand 8b prevents movement of the first strand 8a thereby ensuring that the textile wire element 8 is securely attached to the cam 3. The first strand 8a of the textile wire element 8 is assembled fixedly to the cam 3.

In more general manner, an upline strand wedges a downline strand against a side face of the cam 3. The greater the force applied by the trigger 7, the harder the upline strand wedges the downline strand against the cam and the better the securing. The upline part is the part that is closest to the trigger 7 in the longitudinal direction of the textile wire element 8. This configuration can be used with three, four or more holes passing through the cam 3.

Advantageously, the first strand 8a is a terminal strand of the textile wire element 8 that is wedged against a face of the cam 3 by a second strand 8b of the textile wire element 8. The terminal strand is the part of the textile wire element 8 farthest from the portion connected to the trigger 7.

The fixing can be devoid of adhesive or knots and provide the resistance to the forces applied by the trigger 7 on the cam 3 to oppose the stresses of the spring 9. The thickness of the fixing corresponds substantially to twice the thickness of the textile wire element 8. It is advantageous to perform thinning of a portion of a cam 3 to form a thinned area 3e so that the strand or strands of the textile wire element 8 do not form a salient area extending beyond the dimensions of the cam, i.e. the volume occupied by the cam 3 in its movements between the extended position and the retracted position in the absence of the textile wire element 8.

In an advantageous embodiment illustrated in FIGS. 4, 5a and 5c, the first hole 3a, the second hole 3b and the third hole 3c are aligned through holes. When a force is applied on the textile wire element 8 in the direction of the trigger 7, the first strand 8a and the second strand 8b seek to move in different directions. This arrangement of the two strands tends to make movement of the first strand 8a and the second strand 8b more complicated.

In an alternative embodiment illustrated in FIGS. 10, 12a and 12c, the first hole 3a, the second hole 3b and the third hole 3c are through holes that not aligned, but the cam 3 defines a recess 3f with a wall 3g. the recess 3f is a thinned area. The wall 3g connects the three holes so that the portion of the textile wire element 8 connecting the first hole 3a and the second hole 3b overlaps the third hole 3c in an observation in the second direction YY. The first strand 8a is wedged against the wall of the cam 3 by means of the second strand 8b as for the previous embodiment.

The configurations presented above are particularly advantageous as they enable the textile wire element 8 to be secured with the cam 3 and offer a certain freedom of adjustment of the length of the textile wire element 8. Preferentially, installation of the terminal portion of the textile wire element 8 in a recess of the cam 3 ensures that the excess textile wire element 8 will not hamper the movements of cams 3 with respect to one another.

As an alternative or as a complement to the third hole 3c, the cam 3 can define a the groove 3d on one of its sides. Advantageously, the groove 3d is located after the first hole 3a and after the second hole 3b, along the longitudinal direction of the textile wire element 8 away from the trigger 7. The groove 3d enables a portion of the textile wire element 8 to be wedged, preferably the terminal portion of the textile wire element 8. Preferentially, the groove 3d enables a more or less large quantity of the textile wire element 8 to be wedged, enabling the effective length of the textile wire element 8 to be adjusted.

In preferential manner illustrated in the different FIGS. the groove 3d is arranged between the second hole 3b and the third hole 3c. In addition to having the first strand 8a wedged against the wall of the cam 3 by means of the second strand 8b, the first strand 8a is installed in the groove 3d thereby enabling another wedging of the first strand 8a to be had. The textile wire element 8 is then able to withstand higher stresses.

Advantageously, the groove 3d connects the first hole 3a and the third hole 3c as illustrated in FIGS. 5a and 11a. This configuration enables the trade-off between securing of the textile wire element 8, size of the cam 3 and mechanical strength of the cam 3 to be improved.

In a particular embodiment illustrated in FIGS. 5b, 6b, 11b and 12b, the textile wire element 8 passes successively via the first hole 3a and the second hole 3b in the longitudinal direction of the textile wire element 8 away from the trigger 7 before wedging in the groove 3d and/or passing through the third hole 3c. The successive passages of the textile wire element 8 through the multiple holes induces changes of direction of the textile wire element 8 and therefore friction between the textile wire element 8 and the cam 3. The textile wire element 8 presses on both ends of the first hole 3a, the second hole 3b and the third hole 3c if present. Each pressing generates friction that makes sliding of the textile wire element 8 with respect to the cam 3 more complicated.

In order to obtain a large friction between the textile wire element 8 and the cam 3, it is preferable for at least one of the first hole 3a, the second hole 3b and the third hole 3c to define a sharp edge with the wall that defines the first side or the second side of the cam 3. The angle between the side wall of the hole and the wall of the side is preferably comprised between 75° and 105°, more preferentially equal to 90°.

In advantageous manner, the first hole 3a has a second end with a pressing area having a less sharp edge than at least one other edge on which the textile wire element 8 presses. In other words, the edge of the pressing area of the second end is less sharp than the edge of the pressing area of the first end of the first hole 3a or the edge of any one of the pressing areas of the second hole 3b or of the third hole 3c if present. Preferentially, the first hole 3a has a second end the edge of the pressing area of which is less sharp than the edge of the other pressing area of the first hole 3a and than the edges of the second hole 3b. Even more preferentially, the first hole 3a has a second end the edge of which is less sharp than all the other edges on which the textile wire element 8 presses. What is meant by less sharp is an edge the angle of which between the side wall of the hole and the wall of the side edge of the cam defining the side is farther from the value of 90° than the comparison edge. It is also understood that the pressing area has a larger number of edges, for example two, three or four edges.

Advantageously, the first hole 3a has a second end the pressing area of which is a rounded edge, i.e. not having a sharp edge. When the edge is rounded, it is advantageous for the edge to define a radius that is more than half the thickness of the textile wire element 8, preferably more than twice the thickness of the textile wire element 8. A pressing area with a rounded edge corresponds to a pressing area that has an infinity of edges.

The inventors observed that the stress applied by the trigger 7 on the textile wire element 8 in association with pivoting of the cam 3 has the effect of impairing the textile wire element 8 in the friction area. Such a behaviour is not observed for the other pressing points for which the movements are lesser. By introducing a larger number of edges and preferably a rounded portion, it is possible to improve the lifetime of the textile wire element 8 thereby being able to have a larger choice in the accessible materials and in the usable cross-sections. This in particular enables the cross-section of the textile wire element 8 to be reduced, which is preferable for clamping devices of small size as it enables the cross-sections of the holes, grooves and thinning areas to be reduced.

In a preferential embodiment illustrated in FIGS. 1 to 12c, the first hole 3a and the second hole 3b open into a thinned area of the at least one cam 3. The thinned area represents a thinning at least equal to a thickness of a strand of the textile wire element 8. The thinned area of the first side represents a thinning with respect to the more salient area of the first side. The thinned area of the second side represents a thinning with respect to the more salient area of the second side. The salient character is observed along the pivot axis of the cam 3. The salient area is the area farthest from the mid-plane of the cam and perpendicular to the second direction YY. The use of a thinned area, preferably thinned on each of the sides, enables the cams to be moved towards one another without swivelling of the latter being hampered by the textile wire element 8 that winds its way between the opposite sides.

As indicated in the above, it is preferable for the cross-section of the textile wire element 8 to be smaller than the cross-section of the first hole 3a and of the second hole 3b from one end of the textile wire element 8 to the other in the longitudinal direction of the textile wire element 8. The cross-section is observed in the absence of any stress, in particular a longitudinal tensile stress of the textile wire element 8, to make installation by a person easy to perform.

In a preferential embodiment, the textile wire element 8 is only fixed to the cam 3 by wedging in the groove 3d and/or by friction at the ends of the first hole 3a, of the second hole 3b and of the third hole 3c. This configuration prevents the formation of a knot the position and volume of which are poorly mastered resulting in an uncertainty on the effective length between the trigger 7 and the cam 3. This configuration prevents the formation of an adhesion spot the quality of which may change with time as the clamping device is designed to be used outdoors under various weather conditions.

In a particular embodiment, the camming clamping device has at least two cams 3. A first cam 3′ and a second cam 3″ are fitted swivelling and the textile wire element 8 has a first end fixed to a first cam 3′ and an opposite second end fixed to second cam 3″. The two cams define the holes and/or grooves as the latter have been described in the foregoing. Both of the ends are secured according to one of the embodiments presented in the foregoing.

To manufacture a camming clamping device, both the textile wire element 8 and the camming clamping device as presented according to any one of the above configurations are provided.

The textile wire element 8 is connected to the trigger 7 and the terminal end of the strand of the textile wire element 8 is inserted in the first hole 3a and then in the second hole 3b. The terminal end of the strand then passes through the third hole 3c or through the groove 3d. Preferentially, the terminal end of the strand then passes through the third hole 3c and is then embedded in the groove 3d.

Preferentially, the third hole 3c is provided in the angular sector delineated by the first hole 3a, the axis of rotation of the cam 3 and the second hole 3b. The textile wire element 8 running via the three holes enables a ring to be formed the terminal end of the strand of which is wedged by another strand.

To adjust the textile wire element 8 to the right length, it is advantageous to make the textile wire element 8 pass through the holes and possibly the groove or grooves and to then place the end of the strand in the groove designed to receive this part of the 10 strand or between the last two holes used to secure the textile wire element 8, and to then pull on the trigger 7 to wedge the textile wire element 8 thereby achieving securing with the cam 3.

Preferentially, one end of the textile wire element 8 is fixed to a first cam 3′ before the other end is fixed by means of the method described in the foregoing.

1. A camming clamping device comprising:
a head;
at least one cam installed in movable manner pivoting around at least one pivot shaft, the at least one cam being movable between a retracted position and an extended position, the at least one pivot shaft being fixed to the head, the at least one cam defining at least a first hole and a second hole that are pass-through between a first side and a second side of the at least one cam;
a spring functionally coupled to the at least one cam to bias the at least one cam to the extended position;
an annular end mechanically coupled to the head;
a rod extending from the head to the annular end;
a trigger mounted movable between a first trigger position and a second trigger position,
a textile wire element having a first end installed fixedly with the at least one cam, the textile wire element connecting the trigger mechanically to the at least one cam, the textile wire element linking the trigger functionally to the at least one cam, when the trigger is in the second trigger position the at least one cam is in the retracted position;
wherein the textile wire element passes through the first hole and the second hole to introduce friction between the textile wire element and the at least one cam, and
wherein a terminal portion of the textile wire element passes through a third hole connecting the first side and the second side and/or the terminal portion of the textile wire element is wedged in a groove arranged in the first side or the second side, the terminal portion of the textile wire element being arranged posteriorly to the second hole in a longitudinal direction of the textile wire element away from the trigger.

2. The camming clamping device according to claim 1 wherein the at least one cam defines the third hole and wherein a downline strand of the textile wire element is wedged against a face of the at least one cam by an upline strand of the textile wire element, the downline strand being located farther from more the trigger than the upline strand in the longitudinal direction of the textile wire element.

3. The camming clamping device according to claim 1 wherein the at least one cam defines the at least one groove and wherein a terminal end of the textile wire element is embedded in the at least one groove.

4. The camming clamping device according to claim 3 wherein the at least one groove connects the first hole and the third hole.

5. The camming clamping device according to claim 2 wherein the at least one groove connects the first hole and the third hole, and wherein the downline strand is wedged in the at least one groove

6. The camming clamping device according to claim 1 wherein the textile wire element passes successively via the first hole and the second hole in the longitudinal direction of the textile wire element away from the trigger, wherein the first hole defines a first end with the first side and a second end with the second side, wherein the textile wire element enters the first hole from the second side, the second end forming a second pressing area of the textile wire element and wherein the second pressing area has an edge that is less sharp than an edge of the first end of the first hole and/or less sharp than an edge of the second hole with one and/or the other of the first side and the second side.

7. The camming clamping device according to claim 6 wherein a side wall of the first hole connects a face of the at least one cam forming the second side, and wherein the pressing area of the second end is an arc of a circle having a radius of curvature at least equal to half the thickness of the textile wire element.

8. The camming clamping device according to claim 6 wherein the side wall of the first hole defines a sharp edge with the second face of the at least one cam and/or a side wall of the second hole defines a sharp edge with the first face or the second face of the at least one cam.

9. The camming clamping device according to claim 7 wherein the side wall of the first hole defines a sharp edge with the second face of the at least one cam and/or a side wall of the second hole defines a sharp edge with the first face or the second face of the at least one cam.

10. The camming clamping device according to claim 1 wherein the first hole and the second hole open into a thinned area or a recess of the at least one cam, the thinned area or the recess representing a thinning at least equal to a thickness of a strand of the textile wire element.

11. The camming clamping device according to claim 1 wherein, from one end to of the textile wire element to the other and in the longitudinal direction of the textile wire element, a cross-section of the textile wire element is smaller than a cross-section of the first hole and of the second hole.

12. The camming clamping device according to claim 1 wherein the textile wire element is only fixed to the at least one cam by wedging in the groove and/or by friction at the ends of the first hole, the second hole and the third hole.

13. The camming clamping device according to claim 1 wherein the at least one cam has a first cam and a second cam and wherein the textile wire element has a first end fixed to the first cam and an opposite second end fixed to the second cam.

14. A method for manufacturing a camming clamping device comprising provision of a textile wire element and a camming clamping device provided with:
a head;
at least one cam mounted movable pivoting around at least one pivot shaft, the at least one cam being movable between a retracted position and an extended position, the at least one pivot shaft being fixed to the head, the at least one cam defining at least a first hole and a second hole;
a spring functionally coupled to the at least one cam to bias the at least one cam to the extended position;
an annular end mechanically coupled to the head;
a rod extending from the head to the annular end;
a trigger functionally coupled to the at least one cam, the trigger being mounted movable between a first trigger position and a second trigger position, and in the second trigger position the at least one cam is in the retracted position;
wherein the at least one cam comprises at least a third hole and/or at least one groove;
wherein the textile wire element passes through the first hole, the second hole and the at least a third hole to form consecutive friction areas between the textile wire element and the at least one cam along a longitudinal direction of the textile wire element; and/or
wherein the at least one groove has a width that is less than or equal to a width of the textile wire element, the textile wire element being embedded by deformation in the at least one groove.
